(19) United States
(12) Patent Application Publication
(10) Pub. No.: US 2024/0174068 A1
(43) Pub. Date: May 30, 2024

(54) Sunroof, Moonroof and/or Panoramic Roof Water Leak Protection Cover

(71) Applicant: Krystle Deanna Jackson, Marietta, GA (US)

(72) Inventor: Krystle Deanna Jackson, Marietta, GA (US)

(21) Appl. No.: 18/430,608

(22) Filed: Feb. 1, 2024

Related U.S. Application Data
(60) Provisional application No. 63/511,886, filed on Jul. 4, 2023.

(51) Int. Cl. B60J 11/06

(52) U.S. Cl. CPC B60J 11/06

(57) ABSTRACT

The Sunroof, Moonroof and/or Panoramic Roof Water Leak Protection Cover is a user-friendly, durable, long-lasting, non-breathable, roof cover that goes over a vehicle's closed, leaky or faulty sunroof, moonroof or panoramic roof that prevents water from entering the interior of a vehicle while the vehicle is motionless or in motion, including while the vehicle is being driven. The invention is made with magnetic material which strongly adheres to a vehicle's ferrous metal roof, even while the vehicle is in motion.

### FIELD OF THE INVENTION

The invention relates to a roof cover that goes over a vehicle's sunroof, moonroof or panoramic roof. It prevents water from entering the interior of a vehicle while the vehicle is motionless or in motion, including while the vehicle is being driven.

### BACKGROUND

Vehicle covers have been in our society since around the 1920s and their main purpose are to protect the vehicle from basic hazardous and weather elements such as rain, snow, debris, dust and the like.

There are some vehicle covers that are designed to cover the entire vehicle, from the front of the vehicle to the back of the vehicle, including the top of the vehicle to the vehicle's tires. Also, there are some vehicle covers that are designed to only cover the top-half of the vehicle from the front window of the vehicle to the back window of the vehicle, including the top of the vehicle.

The earliest 1920s designs were commonly crafted from canvas material, however the canvas material was not water-resistant and was susceptible to the weather elements. Therefore, in the 1930s, the vehicle covers were instead designed with water-resistant, synthetic materials, such as polyester.

Between the 1930s and 1980s, the manufacturers began to design higher-quality synthetic material for vehicle covers over the decades and synthetic and polyester material were a popular choice for the vehicle covers' design in-between this timeframe. However, the need for a better and stronger vehicle cover was eventually needed since the synthetic materials commonly made for the vehicle cover before the 1980s frequently were known to rip.

Fast forward to the 1980s, polypropylene became the popular choice in the vehicle covers' material design since this material was high-tech, waterproof and was less-likely to rip easily than the previous vehicles' cover designs. From the 1980s to current, the polypropylene vehicle cover is still being used as one of the most commonly-used vehicle cover types.

In addition to vehicle covers, there are covers that are specifically made for vehicle roofs such as roof mats and roof sunshades.

Today's roof mats are typically made with fabric designed as a protective barrier to go underneath the cargo on top of a vehicle's roof to protect the roof from superficial damages that may be caused by the cargo during transport.

Today's roof sunshades are designed with breathable fabric, such as mesh, made to provide shade from the sun and to reduce vehicle temperature by blocking most of the heat from the sunlight which permeates through the sunroof, moonroof or panoramic roof. The roof sunshades are typically placed within the vehicle underneath the vehicle's sunroof, moonroof or panoramic roof, but can also go over the sunroof, moonroof or panoramic roof.

And lastly, there are sunroof, moonroof and panoramic roof weatherstrips. Also known as weather seals, the weatherstrips are elongated in shape and typically made with rubber. The weatherstrip has adhesive tape on one side which allows the rubber to stick on the outer edge of each side of a vehicle's sunroof, moonroof and panoramic roof. They are cut to size by the vehicle user since each sunroof, moonroof and panoramic roof are designed with different widths and lengths.

### Problems with a Vehicle Cover, Roof Mat, Roof Sunshade and Roof Weatherstrips and the Solution

### Problems with a Vehicle Cover

Although today's current vehicle cover is now commonly-made to be durable, waterproof and protect vehicles from basic hazardous and weather elements, the vehicle cover lacks some benefits. Vehicle covers cannot remain on a vehicle while it is being driven due to the driver's lack of visibility to see through the vehicle cover to drive. In addition, the vehicle cover will more-than-likely fly off the vehicle while the vehicle is in motion due to a vehicle cover's loose fit over the vehicle. There are some vehicle brands that have sunroofs, moonroofs and panoramic roofs that commonly leaks rainwater into the interior of the vehicle while the sunroof, moonroof or panoramic roof is closed which may cause moldy and wet conditions inside the vehicle. This water leak is typically caused by a faulty sunroof, moonroof or panoramic roof or by a sunroof, moonroof or panoramic roof drain that becomes clogged by particles preventing rainwater from properly draining from the sunroof, moonroof or panoramic roof to the outside of the vehicle.

So what happens when the vehicle is in motion and it is raining and the rainwater is leaking through the sunroof, moonroof or panoramic roof? The driver will do one of two methodical options—park the vehicle, turn the vehicle's ignition off and then place the vehicle cover over the vehicle to prevent the rainwater from leaking inside the vehicle in order to prevent risks such as mold development or wet conditions in the interior of the vehicle. The other option the driver has it to continue to drive the vehicle while the rainwater is leaking into the interior of the vehicle and risk mold development in the vehicle's interior or wet conditions inside the vehicle. To stop the vehicle and put the vehicle in park to place a cover over the vehicle and wait until the rain stops is not always the feasible option when a driver is, for example, on their way to work, driving to an emergency or picking up their kids from daycare. As well, it is not in the driver's best interest, nor in the vehicle passengers' best interest, to continue to utilize a vehicle with a leaky roof with no vehicle cover to prevent the rainwater leak into the vehicle's interior which can cause mold development and adversely affect individuals' health. Therefore, there needs to be a roof cover that can go over the leaky sunroof, moonroof and panoramic roof while a vehicle is in motion or being driven to prevent moldy and wet conditions.

Also, the vehicle cover may be cumbersome to handle since it is typically large and bulky which prevents the vehicle owner from quickly putting on the vehicle cover or taking it off. Vehicle owners typically want an easier and a more user-friendly solution to quickly cover and protect their closed, leaky sunroof, moonroof and panoramic roof.

In addition, although a faulty or leaky sunroof, moonroof or panoramic roof can be fixed or roof drains properly cleaned to prevent a water leak from happening, sometimes vehicle owners want a simple and quick fix or want a temporary solution until they can fix it themselves or take it to a vehicle mechanic to fix it. Also, the vehicle owner may not have the proper equipment on hand to fix the roof or clean the roof drain. A user-friendly roof cover that a vehicle owner can quickly put over their sunroof, moonroof or panoramic roof will solve this problem immediately.

And lastly, the vehicle cover is portable and can be placed in the back of a vehicle's trunk for storage, but it's not ideal due to a vehicle cover's bulkiness which may take up a lot of space in the trunk due to it being cumbersome to fold tightly. Also, the vehicle cover has a tendency to retain dirt, debris and water on the outside of the cover (the cover's outside may still be wet after a recent rain shower) which may transfer to the trunk's interior and/or carpeting. A cover, such as a roof cover, that receives less dirt and debris, is quick-drying and has better storage capability is more desirable to the vehicle owner.

### Problems with a Roof Mat

Roof mats are not adhesive to the top of a vehicle's roof and they are typically made with breathable material. They are specifically designed as just a loosely, protective barrier to a vehicle's roof while cargo is in transport on top of it. The roof mat will not stay on the vehicle while the vehicle is in motion unless there is cargo on top of it and it will not stop rainwater from coming through into the faulty or leaky sunroof, moonroof or panoramic roof.

### Problems with a Roof Sunshade

Roof sunshades are made with breathable, porous material and are not waterproof. They are designed specifically for shade from the sun and to provide cooler temperatures in the vehicle's interior by blocking most of the sun's rays which causes heat to enter through the vehicle's sunroof, moonroof or panoramic roof. Because the roof sunshade is porous, it will not protect rainwater from entering the vehicle's interior.

### Problems with Roof Weatherstrips

Roof weatherstrips are adhesive to the top of the roof, customizable, waterproof, and are designed to prevent rainwater from entering the vehicle's interior, however there are some major setbacks to the weatherstrip. The adhesive side of the weatherstrip frequently peels off the vehicle's roof top after a very short time, particularly if the vehicle is in motion, the weatherstrip is bumped, or becomes agitated by the weather elements. Because of this, the vehicle user will be constantly replacing the weatherstrips which is very inconvenient and becomes a cumbersome task.

### The Solution

There needs to be a durable, long-lasting, non-breathable roof cover that goes over the faulty or leaky sunroof, moonroof and panoramic roof to prevent rainwater from entering the interior of the vehicle. The roof cover needs to have a strong and tight adherence to the vehicle's ferrous metal roof while the vehicle is in motion, including while the vehicle is being driven. Also, the roof cover needs to be easy to use, handle and store away when no longer being used.

### Description of the Invention and Implementation

The Sunroof, Moonroof and/or Panoramic Roof Water Leak Protection Cover is an apparatus made from durable, long-lasting, non-breathable material, such as magnetic material, and a waterproof coating or substance may be coupled to the roof cover apparatus or mixed into the magnetic material to make the roof cover waterproof. The roof cover strongly adheres tightly to the top of the vehicle's ferrous metal roof by magnetism or a magnetic force and goes over the entire vehicle's sunroof, moonroof or panoramic roof to prevent water, such as rainwater, from leaking or coming inside the vehicle. The roof cover is designed to stay on top of the vehicle while the vehicle is motionless or in motion, including while the vehicle is being driven. The roof cover is also more user-friendly than a vehicle cover since it can be placed quickly over the affected area (the leaky, closed sunroof, moonroof or panoramic roof), is easier to fold (material is rolled, compactly) and can be stored conveniently in compact spaces such as the trunk of a vehicle. The roof cover also collects less debris, dirt and water on the outside of the roof cover in comparison with a vehicle cover. With less water being collected on the outside of the roof cover, the roof cover is also more quick-drying than a vehicle cover.

The Sunroof, Moonroof and/or Panoramic Roof Water Leak Protection Cover's thickness may be 30 mils, but can be more or less than 30 mils in thickness and the roof cover varies in size, width, length and/or height. The roof cover may be of any shape, including rectangular or square in shape. The roof cover may be no longer than the dimensions of the vehicle's metal roof dimensions as shown in the examples in FIG. 2 (Sunroof Water Leak Protection Cover), FIG. 3 (Moonroof Water Leak Protection Cover) and FIG. 4 (Panoramic Roof Water Leak Protection Cover).

### DESCRIPTION OF THE DRAWINGS

FIG. 1 shows the easy placement of the non-breathable roof cover apparatus 2 over a vehicle's ferrous metal roof 3 covering a closed, leaky or faulty sunroof (which can also be seen in the drawing as a moonroof or panoramic roof) 4. The non-breathable roof cover over the vehicle's sunroof, moonroof or panoramic roof is preventing the rainwater 1 from entering the vehicle's interior.

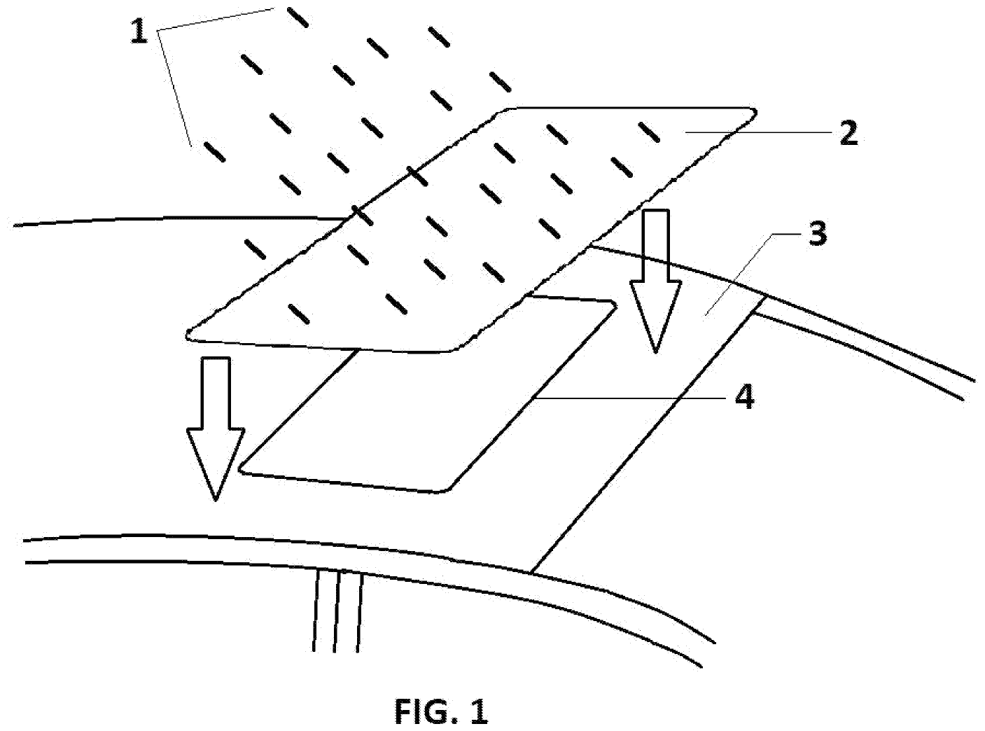

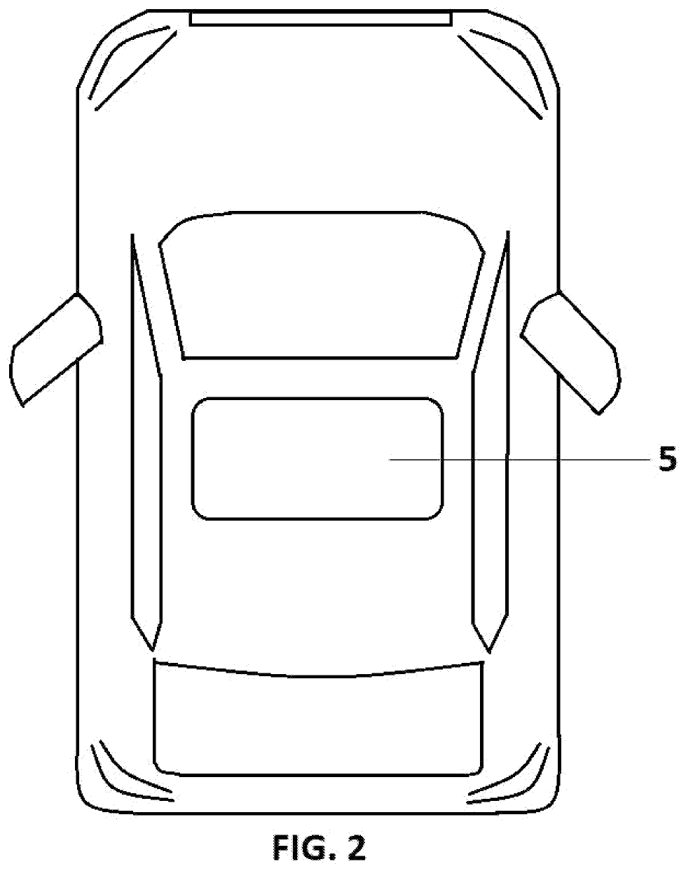

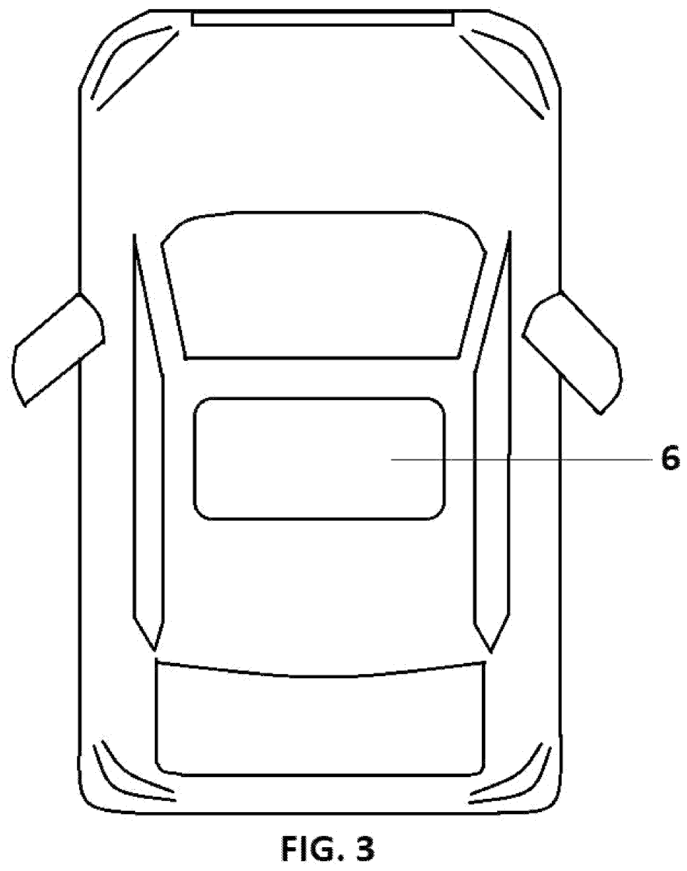

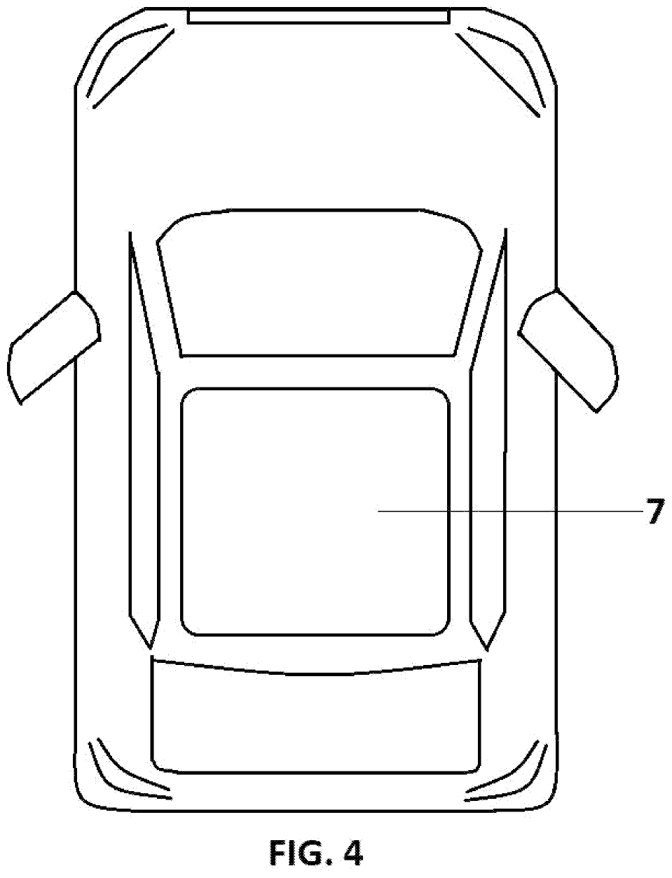

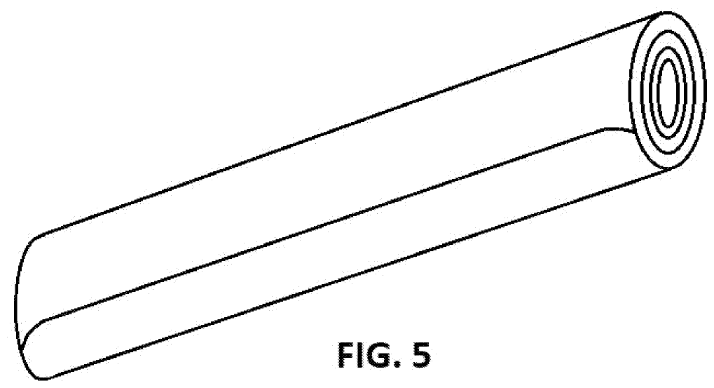

Shown in FIG. 2 is an example of the Sunroof Water Leak Protection Cover tightly affixed over a vehicle's sunroof. The vehicle shown in FIG. 2 can be motionless or in motion, with the roof cover adhering strongly in-place over the vehicle's roof. The roof cover 5 is tightly adhering to the ferrous metal roof of the vehicle by a strong magnetism or magnetic force. The roof cover is shown rectangular in the drawing, but may be of any shape. The roof cover is no longer than the dimensions of the vehicle's metal roof dimensions. The roof cover's thickness is typically around 30 mils, but can be more or less than 30 mils in thickness and the roof cover varies in size, width, length and/or height.

Shown in FIG. 3 is an example of the Moonroof Water Leak Protection Cover tightly affixed over a vehicle's moonroof. The vehicle shown in FIG. 3 can be motionless or in motion, with the roof cover adhering strongly in-place over the vehicle's roof. The roof cover 6 is tightly adhering to the ferrous metal roof of the vehicle by a strong magnetism or magnetic force. The roof cover is shown rectangular in the drawing, but may be of any shape. The roof cover is no longer than the dimensions of the vehicle's metal roof dimensions. The roof cover's thickness is typically around 30 mils, but can be more or less than 30 mils in thickness and the roof cover varies in size, width, length and/or height.

Shown in FIG. 4 is an example of the Panoramic Roof Water Leak Protection Cover tightly affixed over a vehicle's panoramic roof. The vehicle shown in FIG. 4 can be motionless or in motion, with the roof cover adhering strongly in-place over the vehicle's roof. The roof cover 7 is tightly adhering to the ferrous metal roof of the vehicle by a strong magnetism or magnetic force. The roof cover is shown square in the drawing, but may be of any shape. The roof cover is no longer than the dimensions of the vehicle's metal roof dimensions. The roof cover's thickness is typically around 30 mils, but can be more or less than 30 mils in thickness and the roof cover varies in size, width, length and/or height.

Shown in FIG. 5 is an example of how the Sunroof, Moonroof and/or Panoramic Roof Water Leak Protection Cover is folded after use. The roof cover can be easily removed from a vehicle's roof and can be rolled compactly which can be then conveniently placed inside of a vehicle's trunk for storage.

### Summary

The Sunroof, Moonroof and/or Panoramic Roof Water Leak Protection Cover is meant to give a vehicle, a vehicle owner/user and vehicle passengers an added benefit in which the vehicle cover, roof mat, roof sunshade and roof weatherstrips lacks or a more convenient apparatus option. The Sunroof, Moonroof and/or Panoramic Roof Water Leak Protection Cover provides a water leak protection solution to a vehicle's interior while the vehicle is in motion (or motionless) which in turn, prevents undesirable and hazardous conditions such as mold development and a wet vehicle interior. The Sunroof, Moonroof and/or Panoramic Roof Water Leak Protection Cover adheres strongly and tightly to a vehicle's ferrous metal roof, including while the vehicle is being driven. Also, it is a more user-friendly option, folds tightly for better storage capability and provides a quick leak fix for a vehicle, a vehicle owner/user and vehicle passengers.

### Definitions

The term roof cover as explained in this utility patent application relates to this application's invention.

The term apparatus as explained in this utility patent application relates to this application's invention.

The term roof cover apparatus as explained in this utility patent application relates to this application's invention.

The term vehicle cover as explained in this utility patent application is defined as a cover that goes over the entire vehicle or the top-half of the vehicle.

The term roof mat as explained in this utility patent application is defined as a breathable material that loosely goes over the sunroof, moonroof or panoramic roof to provide protection from superficial damages to the vehicle's roof from cargo on top of the roof mat during cargo transportation.

The term roof sunshade as explained in this utility patent application is defined as a breathable fabric, such as mesh, that covers the sunroof, moonroof or panoramic roof to provide shade from the sun and to reduce heat to the inside of the vehicle from the sun's rays.

The term roof weatherstrip as explained in this utility patent application is defined as a customizable, rubber, elongated strip with an adhesive side that adheres to the outer edge of the sunroof, moonroof or panoramic roof.

What is claimed is:

1. An apparatus for covering a vehicle's roof, the apparatus comprising,
a removable roof cover in the form of a shape, such as a square or rectangle;
comprising mostly magnetic material; and
comprising non-breathable material.

2. The roof cover as defined by claim 1 thickness may be 30 mils, but can be more or less than 30 mils in thickness and the roof cover varies in size, width, length and/or height.

3. The roof cover as defined by claim 1 may further comprise waterproof material.
